(19) United States
(12) Patent Application Publication
(10) Pub. No.: US 2018/0186262 A1
(43) Pub. Date: Jul. 5, 2018

(54) VEHICLE SEAT ACCESSORY

(71) Applicant: GM GLOBAL TECHNOLOGY OPERATIONS LLC, Detroit, MI (US)

(72) Inventor: Anna M. Saadatjoo, Huntington Woods, MI (US)

(21) Appl. No.: 15/396,894

(22) Filed: Jan. 3, 2017

(51) Int. Cl. B60N 2/58

(52) U.S. Cl. CPC B60N 2/5816; B60N 2002/4405

(57) ABSTRACT

An accessory adapted to releasably affix to at least one rail of the adjustable headrest for a vehicle seat is herein presented. The accessory includes a body and grommet. The body has an aperture. The grommet is inserted and joined to the aperture and can releasably affix the accessory to the adjustable headrest rail.

In the event of a vehicle user returning from a beach, waterpark, or gym, their clothes may be wet. As such, they may find sitting on one of the vehicle seats to be an uncomfortable experience due to the seat being overexposed to sun light, or they may simply not want to transfer moisture from their clothes onto the upholstery. It would therefore be desirable to provide an accessory which can create a moisture-absorbent barrier between the user's clothes and vehicle seat.

### SUMMARY

An accessory adapted to releasably affix to at least one rail of the adjustable headrest for a vehicle seat is herein presented. The accessory includes a body and grommet. The body has an aperture. The grommet is inserted and joined to the aperture and can releasably affix the accessory to the adjustable headrest rail.

In certain embodiments, the body may further include a second aperture. In these embodiments, the second grommet is inserted and joined to the second aperture and can releasably affix to the adjustable headrest rail. The body may include a communication section or pocket or both. The body may be manufactured from a sheet of textile fabric. The textile fabric may be cotton, rayon, polyester, bamboo, or some combination thereof. The textile fabric may moreover be defined by a terrycloth configuration, or a honeycomb fabric configuration, or a microfiber configuration.

The grommet may be manufactured from polymeric material, elastomeric material, metallic material, wood material, fiberglass material, fabric, or some combination thereof. The grommet may have a living hinge and a snaplock mechanism. Moreover, the snaplock mechanism may have a key adapted to interlock with a corresponding notch. The grommet may otherwise have a slit adapted to enable the grommet to releasably affix to the adjustable headrest rail.

A method of releasably affixing an accessory to the rails of the adjustable headrest for a vehicle seat is also presented herein. The method includes the following steps: providing an adjustable vehicle seat headrest with at least one rail configured to connect the headrest and vehicle seat; adjusting the vehicle seat headrest to expose the rail to the vehicle interior environment; providing the accessory presented herein; and releasably affixing the accessory to the exposed rail. The method may further include the step of allowing an object to rest on the vehicle seat such that the releasably affixed accessory is situated between the object and vehicle seat.

### BRIEF DESCRIPTION OF THE DRAWINGS

FIG. 1 shows a perspective view of an exemplary vehicle seat accessory in an exemplary environment;

FIG. 2 is a front view of the vehicle seat accessory of FIG. 1;

FIG. 3 is a front view of an exemplary grommet for the vehicle seat accessory;

FIG. 4 is a side view of the vehicle seat accessory of FIG. 1 being used in an exemplary manner; and

FIG. 5 is a side view of the vehicle seat accessory of FIG. 1 being used in another exemplary manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

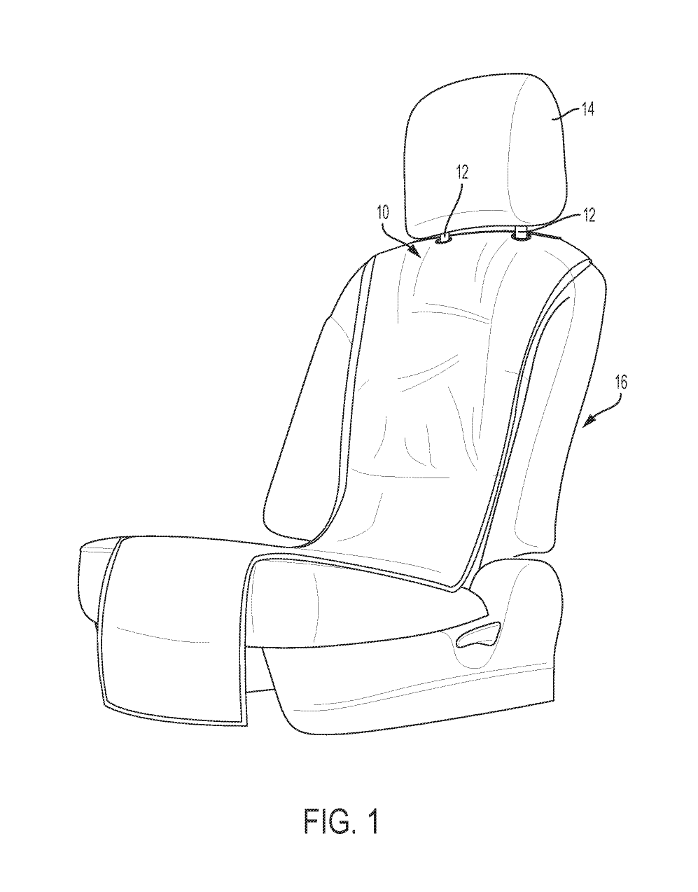

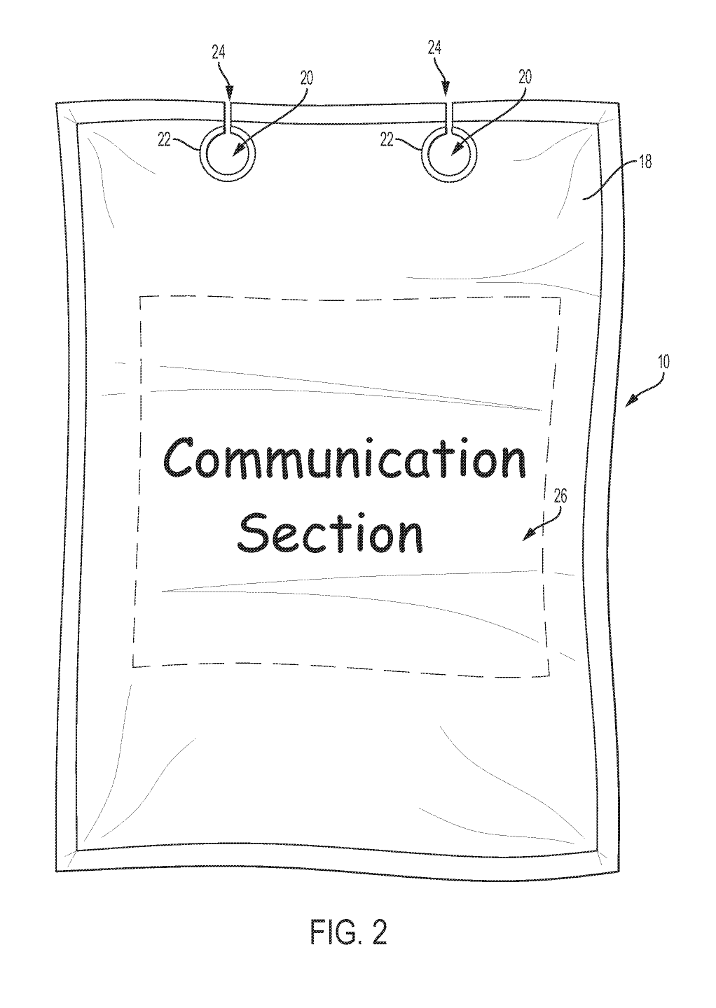

As shown in FIG. 1, an exemplary accessory 10 may be affixed to rails 12 of an adjustable headrest 14 for a vehicle seat 16. With reference to FIG. 2, it can be seen that accessory 10 incorporates a sheet of textile fabric 18 with two apertures 20 of a similar size and shape. A nylon split-ring grommet 22 is moreover installed onto each aperture 20, as is generally known by being inserted into and joined to the aperture 20 through compression. The fabric 18 may moreover be, but is not limited to, cotton, rayon, polyester, bamboo, or some combination thereof. As shown, in this embodiment, fabric 18 is sized to cover substantially the entire vehicle seat upholstery. However, skilled artisans will see that fabric 18 may be manufactured to various other sizes.

The grommet split 24 allows accessory 10 to be affixed to rail 12 in a releasable manner. As can be thus understood, an accessory user must simply apply a slight twist to each grommet 22, so as to expand the width of the grommet split 24 (and corresponding fabric break) and allow a corresponding portion of rail 12 to be inserted there between. Skilled artisans will also see that each split-ring grommet may also be manufactured from polymeric material (i.e., plastics other than nylon), elastomeric material (e.g., rubber), metallic material (e.g., stainless steel), wood, fiberglass, enforced fabric, or some combination thereof.

In this embodiment, fabric 18 defines accessory 10 as a flexible, moisture-absorbent towel. As such, fabric 18 may have a terrycloth configuration. In other words, as is generally known, numerous fabric loops (i.e., hundreds of long loops) may be woven or knitted into the fabric 18 to facilitate absorption of moisture. In other embodiments, however, fabric 18 may have a honeycomb fabric configuration (otherwise known as waffle fabric). In such embodiments, as is generally known, fabric 18 has a waffle weave that allows air to flow through so as to facilitate moisture to release and allow fabric 18 to dry. Other alternative embodiments of fabric 18 may have a microfiber configuration. In such embodiments, as is generally known, fabric 18 will have numerous synthetic fibers each of which being generally finer than one denier or decitex/thread.

A section 26 of fabric 18 may moreover be dedicated to viewable communications to/from the accessory user. For example, an advertiser may communicate a product or service in section 26. In this instance, the communication may be a logo, slogan, or tradename. In another example, the accessory user may themselves have a unique customized communication placed in section 26. For instance, the user may have a personalized initial monogram placed in section 26. Skilled artisans will further see such communications may be inserted in section 26 through known methodologies such as, but not limited to, embroidery and silk screening.

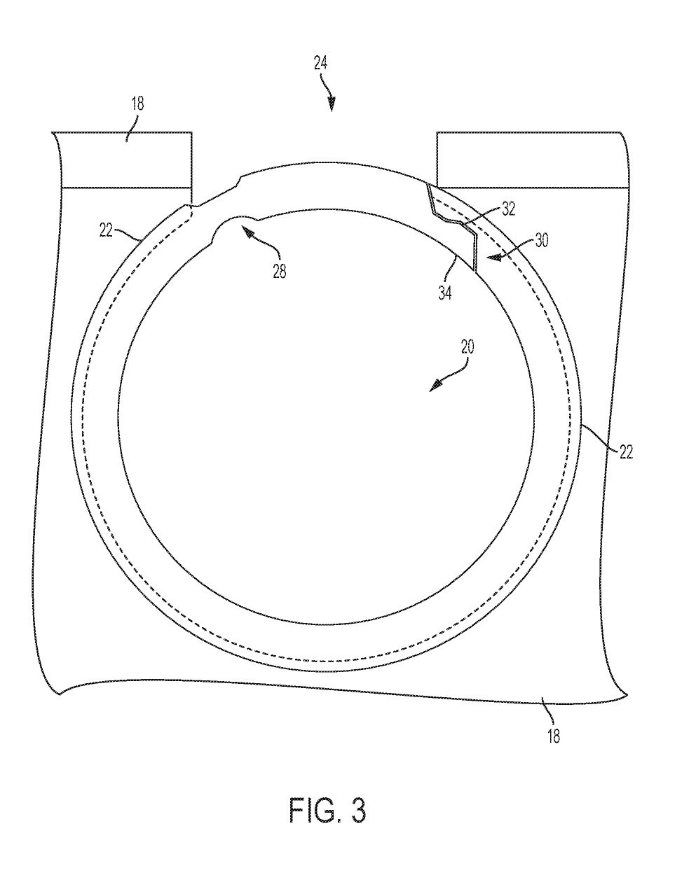

As shown in FIG. 3, another embodiment of the split-ring grommets 22 includes a living hinge 28 and snaplock mechanism 30. The living hinge 28 is essentially a thin flexible hinge (flexure bearing) made from the same material as the rest of the corresponding grommet 22. As such, grommet portions considered living hinge 28 are generally thinned (or cut) to allow the rest of grommet 22 to bend along the line of the hinge 28. Furthermore, snaplock mechanism 30 includes a key portion 32 which is adapted to interlock with a corresponding notch portion 34. The notch portion 34 may further be embodied as an exposed cavity located centrally along the body of grommet 22.

As can thus be understood, an accessory user is simply required to place radially inward pressure on the portion of grommet 22 between living hinge 28 and snaplock mechanism 30, such that the key portion 32 and notch portion 34 separate and form a gap. The user will then have to allow a corresponding portion of rail 12 to be inserted into this newly created gap. Once this has been done, to fully affix accessory 10, the user will simply have to release pressure on grommet 22, so as to allow spring force to close the gap and lock these grommet features back together.

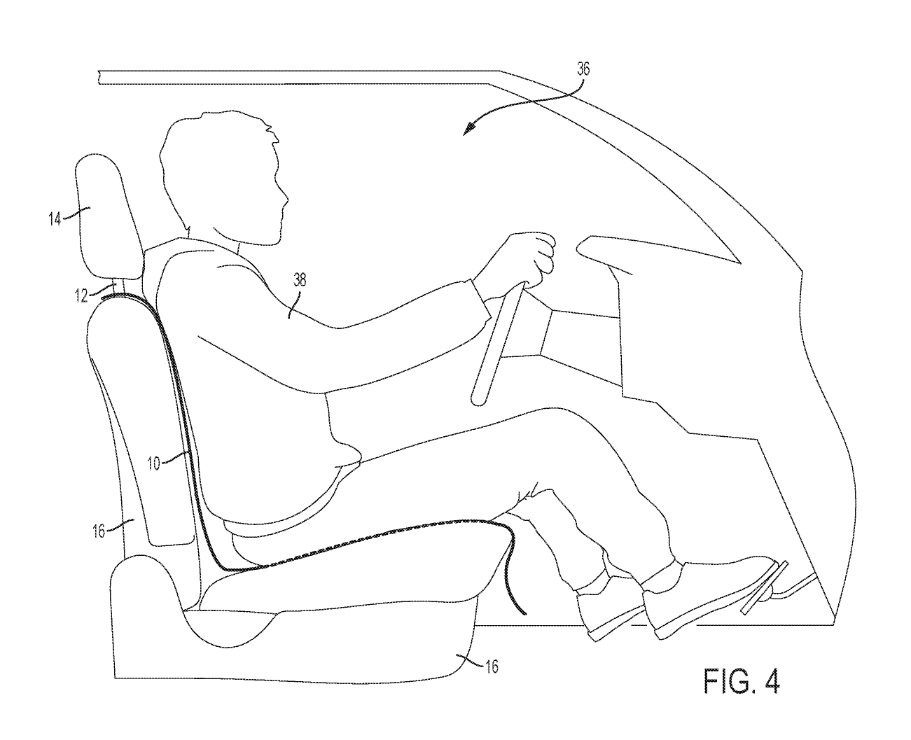

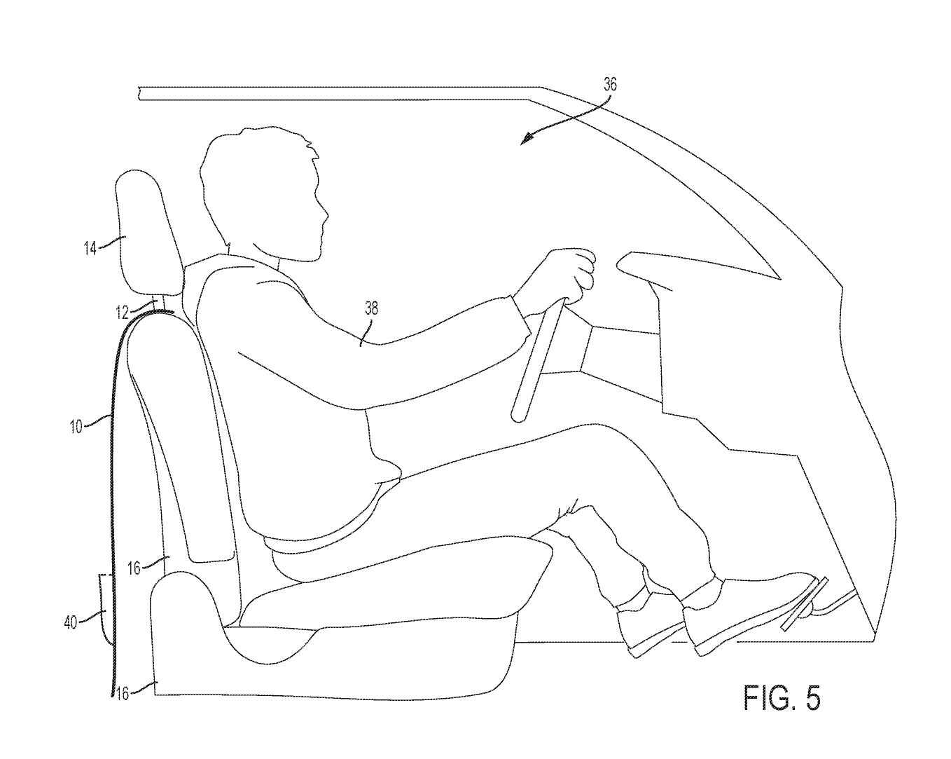

Referring to FIGS. 4 and 5, to properly use the accessory 10, while in the vehicle interior 36, an accessory user 38 will simply need to conduct a few simple steps. First, user 38 will have to ensure headrest 14 has been adjusted to expose the rails 12 to access vehicle interior 36. Next, user 38 will simply have to affix the accessory to the exposed portions of each rail 12, as discussed above with reference to each exemplary grommet embodiment. In turn, while operating the vehicle in soiled clothing, user 38 (or some other object) can rest on the releasably affixed accessory 10, which is now situated between user 38 and vehicle seat 16 (FIG. 4). Moreover, when user 38 is finished using accessory 10, or accessory 10 has become saturated with moisture, they can adjust the accessory 10 to be draped behind seat 16. This will allow the moisture to evaporate from fabric 18 while remaining in vehicle interior 36. Furthermore, as shown, in certain embodiments, fabric 18 may additionally have a pocket 40 sewn in (or joined via adhesives), for storing various items such as wallets and candy and to help keep vehicle interior 36 organized.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An accessory adapted to releasably affix to at least one rail of the adjustable headrest for a vehicle seat, the accessory comprising:
a body comprising an aperture; and
a grommet inserted and joined to the aperture, the grommet adapted to releasably affix to the adjustable headrest rail.

2. The accessory of claim 1, wherein:
the body further comprising a second aperture; and
a second grommet inserted and joined to the second aperture, the second grommet adapted to releasably affix to the adjustable headrest rail.

3. The accessory of claim 1, wherein the body comprises a communication section.

4. The accessory of claim 1, wherein the body comprises a pocket.

5. The accessory of claim 1, wherein the body is manufactured from a sheet of textile fabric.

6. The accessory of claim 5, wherein the textile fabric is cotton, rayon, polyester, bamboo, or some combination thereof.

7. The accessory of claim 5, wherein the textile fabric is defined by a terrycloth, honeycomb fabric, or microfiber configuration, or some combination thereof.

8. The accessory of claim 1, wherein the grommet is manufactured from polymeric material, elastomeric material, metallic material, wood material, fiberglass material, fabric, or some combination thereof.

9. The accessory of claim 1, wherein the grommet comprises a living hinge and a snaplock mechanism.

10. The accessory of claim 9, wherein the snaplock mechanism comprises a key adapted to interlock with a corresponding notch.

11. The accessory of claim 1, wherein the grommet comprises a slit adapted to enable the grommet to releasably affix to the adjustable headrest rail.

12. An accessory adapted to releasably affix to the rails of the adjustable headrest for a vehicle seat, the accessory comprising:
a sheet of textile fabric comprising a plurality of apertures; and
a nylon grommet inserted and joined to each of the plurality of apertures, each grommet comprising a slit adapted to releasably affix the sheet of textile fabric to the adjustable headrest rail.

13. The accessory of claim 12, wherein the body comprises a communication section.

14. The accessory of claim 12, wherein the body comprises a pocket.

15. The accessory of claim 12, wherein the textile fabric is cotton, rayon, polyester, bamboo, or some combination thereof.

16. The accessory of claim 12, wherein the textile fabric is defined by a terrycloth, honeycomb fabric, or microfiber configuration, or some combination thereof.

17. A method of releasably affixing an accessory to the rails of the adjustable headrest for a vehicle seat, the method comprising:
providing an adjustable vehicle seat headrest comprising at least one rail configured to connect the headrest and vehicle seat;
adjusting the vehicle seat headrest to expose the rail to the vehicle interior environment;
providing an accessory, the accessory comprising:
a sheet of textile fabric comprising an aperture; and
a nylon grommet inserted and joined to the aperture; and
releasably affixing the accessory to the exposed rail.

18. The method of claim 17, further comprising allowing an object to rest on the vehicle seat such that the releasably affixed accessory is situated between the object and vehicle seat.

19. The method of claim 17, further comprising allowing the releasably affixed accessory to drape behind the vehicle seat.

20. The method of claim 17, wherein the textile fabric is cotton, rayon, polyester, bamboo, or some combination thereof.
